(19) United States
(12) Patent Application Publication
(10) Pub. No.: US 2004/0122575 A1
(43) Pub. Date: Jun. 24, 2004

(54) Device for detecting a seating position of a passenger in a motor vehicle

(76) Inventor: Reiner Marchthaler, Gingen (DE)

Correspondence Address: KENYON & KENYON, ONE BROADWAY, NEW YORK, NY, 10004, US

(21) Appl. No.: 10/658,060

(22) Filed: Sep. 9, 2003

(30) Foreign Application Priority Data
Sep. 11, 2002 (DE) 10242113.7

(51) Int. Cl. G05D 1/00

(52) U.S. Cl. 701/49

(57) ABSTRACT

A device is provided for detecting a seating position of a passenger in a motor vehicle, the device being characterized in that it outputs at least one instruction to the passenger for adjusting the seat as a function of a signal from a sensory system. The instructions may be output at predefined points in time that minimize a driver's loss of concentration.

### BACKGROUND INFORMATION

From German Patent Application No. DE 198 51 698, a seat is known that is automatically adjusted as a function of a pressure-sensor signal.

Disadvantageous in the design approach introduced by German Patent Application No. DE 198 51 698 is that it cannot be used in motor vehicles that are not provided with driving means for an automatic adjustment of the seat.

It is an objective of the present invention to further refine a device for detecting a seating position of a passenger in a motor vehicle, in such a way that it allows an improved adjustment of the seat in a motor vehicle without automatic seat adjustment.

### SUMMARY OF THE INVENTION

The device according to the present invention for detecting a seating position of a passenger in a motor vehicle has the advantage over the related art that it records the instantaneous seating position of the passenger as a function of the signal from the sensory system and outputs instructions for adjusting the seat. These instructions may be output optically and/or acoustically. It is possible to output these instructions repeatedly or for a certain period of time, or to output these instructions only in a stopped vehicle. In this way, it is prevented that a driver is distracted while driving. By using the device according to the present invention, the passenger, in an advantageous manner, will sit in the correct position at all times, so that strains or back injuries are avoided and the restraining means are able to provide an optimal protection, since the passenger is guided to assume a seating position that allows the best use of the restraining system.

It is particularly advantageous that the device includes a switch whose activation induces the device to trigger driving means in the seat as a function of the signal.

Should a motor vehicle be equipped with driving means, such as adjusting motors, in the area of the head rest, the seat backrest and the seat pad, a driver or a person inside the vehicle may then cause the device to implement this adaptation automatically, by activating the switch, so that the optimal seating position of the passenger does not require an intervention by the passenger himself. The switch may be provided for each seat in the vehicle, but it may also be implemented in the form of a central switch for all seats.

The sensory system for recording the seating position of the respective passenger may operate optically and/or acoustically. However, it is also possible to use weight sensors, such as a seat mat or weight sensors in the seat supports, to detect the seating position.

### BRIEF DESCRIPTION OF THE DRAWING

FIG. 1 shows a schematic representation of a device according to the present invention.

### DETAILED DESCRIPTION

At present, the available airbag systems are designed for a passenger sitting in a normal seating position. This seating position represents an important parameter not only for the restraining systems, but also for a plurality of other comfort functions. The seating position plays a principal role in particular in the new development of a vehicle passenger compartment. However, drivers often do not recognize an ideal seating position and assume an incorrect seating position while driving. This may result not only in tension or damage to the back due to incorrect seating positions, but it is also possible that the passenger, in the event of a crash, would not be optimally protected by the restraining system.

According to the present invention, a device is therefore provided that records the position of the vehicle passenger with the aid of the sensory system and, as a function thereof, outputs instructions to the passenger as to which seating position to assume or how to adjust the seat to achieve an optimal seating position. In addition, a switch is provided which, in vehicles having electrically controllable driving means in the seat for adjusting the seat, allows these to be switched in to trigger them in an appropriate manner to detect the seating position as a function of the signal from the sensory system. In this case, the device is able to automatically implement an optimal adjustment of the seating position. These driving means are arranged in the area of the head rest, the seat backrest and the seat pad, and for the most part are embodied as control motors. However, other driving means are conceivable as well, such as pneumatic driving means, and hydraulic driving means. The sensory system for detecting the seating position may sense optically, acoustically, using ultrasound, for instance, or via various weight sensors installed directly in the seat.

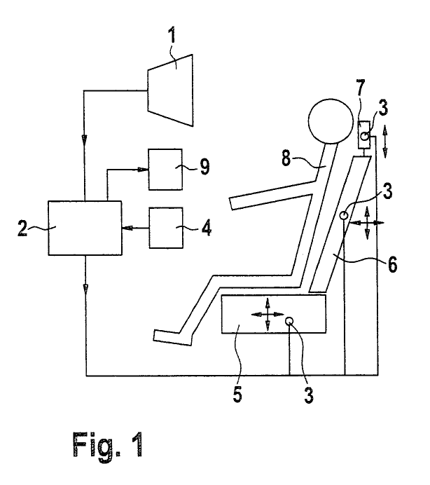

FIG. 1 shows a schematic representation of the device according to the present invention. In this case, a sensory system 1 is connected to a data input of an evaluation electronics 2. Sensory system 1 is disposed in such a manner that it may detect a seat having the elements seat pad 5, seat backrest 6 and head rest 7, and may thus detect passenger 8 present on seat 5, 6, 7 as well. Evaluation electronics 2 then evaluates the sensor signal from sensory system 1. In this way, evaluation electronics 2, which includes a processor, is able to determine the seating position of passenger 8. This seating position is then compared to stored values for the ideal seating position, and evaluation electronics 2, as a function of deviations from this ideal seating position, transmits to output 9 a corresponding signal, output 9 in this case being embodied as a display. Display 9 thereupon displays instructions to passenger 8 as to how to adjust seat 5, 6, 7 in order to assume an optimal seating position. Alternatively, or additionally, it is possible that output 9 is not only embodied as a display, but as a loudspeaker as well, so as to output spoken instructions to passenger 8. This output of the spoken or graphical representation may occur for a certain period of time or be repeated or also take place only while the vehicle is stopped. This means, in particular, that in a non-stationary vehicle, passenger 8, who may be the driver himself, for example, is not distracted by such instructions from concentrating on vehicle traffic. If seat 5, 6, 7, as shown here, includes control motors 3 in head rest 7, seat backrest 6 and seat pad 5, passenger 8 is able to cause evaluation electronics 2 to adjust these control motors as a function of the signal from sensory system 1 via a switch 4. In addition, it is possible that evaluation electronics 2 provides instructions to passenger 8, via output 9, to the effect that he is to assume a different seating position by changing his posture.

Switch 4 may be configured as toggle switch or as rotary switch and may either be the only switch for the entire vehicle or for each individual seat.

Sensory system 1 may monitor passenger 8 in a continuous manner. As represented above, the output of instructions to passenger 8 may occur at predefined times. These points in time are, for example, the non-moving vehicle, i.e., when stopped at a traffic light, for example, or also when the vehicle moves at a uniform speed. Other vehicle movements, for instance a slow movement in backed-up traffic or in slow-moving traffic, may also be used for such an output. Various output instants may be used for these instructions under these circumstances.

What is claimed is:

1. A device for detecting a seating position of a passenger in a seat of a motor vehicle, comprising:
a sensory system for providing a signal indicative of the seating position of the passenger in the seat of the motor vehicle; and
an arrangement for outputting at least one instruction for adjusting the seat as a function of the signal from the sensory system.

2. The device according to claim 1, further comprising:
a switch whose activation induces the device to trigger a driving device in the seat as a function of the signal.

3. The device according to claim 2, wherein the driving device is situated in a region of a head rest, a seat backrest and a seat pad.

4. The device according to claim 1, wherein the sensory system is one of an optical and an acoustical system.

5. The device according to claim 1, wherein the arrangement outputs the at least one instruction to the passenger at predefined points in time.
